(19) United States
(12) Patent Application Publication
(10) Pub. No.: US 2009/0271490 A1
(43) Pub. Date: Oct. 29, 2009

(54) Communication Protocols Based on Mutuality

(76) Inventor: Rudi Seitz, Boston, MA (US)

Correspondence Address: KEYBRIDGE LAW OFFICE, LC, 165 FRIEND ST., UNIT 5, BOSTON, MA, 02114, US

(21) Appl. No.: 12/430,873

(22) Filed: Apr. 27, 2009

Related U.S. Application Data
(60) Provisional application No. 61/048,045, filed on Apr. 25, 2008.
(60) Provisional application No. 61/059,674, filed on Jun. 6, 2008.

(51) Int. Cl. G06F 15/16

(52) U.S. Cl. 709/206; 707/104.1; 707/E17.032

(57) ABSTRACT

A communication system that conditions initiation of communication and delivery of messages on party mutuality, and optionally, other mutuality conditions such as topic mutuality. One of the advantages of the present system is its ability to deliver messages otherwise undeliverable due to the lack of a unique and specific recipient address. The present system achieves this by matching messages that employ fuzzy addressing schemes.

### CROSS-REFERENCE TO RELATED APPLICATIONS

This application claims the priority of U.S. Provisional Application Nos. 61/048,045 and 61/059,674, filed on Apr. 25, 2008 and Jun. 6, 2008, respectively, the disclosures of which are both incorporated herein by reference in their entirety.

### BACKGROUND OF THE INVENTION

When one party has a certain interest in a particular issue relating to another party, such as a romantic or business interest, it may be difficult for that party to express its interest to the other party due to concerns of pride, negotiating position, social norms, or tact. For instance, A and B met at an event in the company of friends. A might want to express a romantic interest in B but is afraid of being rejected. Therefore, there is reluctance to initiate communication in fear of a negative response.

On the receiving end of communications is an equally frustrating issue of unwanted solicitations, often in massive amounts. Whether they are telemarketing calls or junk electronic mails (emails), unwanted solicitations waste time and reduce work efficiency, not to mention they have become vehicles of pyramid schemes, fraud and other crimes.

### SUMMARY OF THE INVENTION

The present invention provides communication systems where initiation of communication and message delivery are conditional. By default, messages are held or dropped. In fact, the default in the new system is non-delivery in contrast to delivery in conventional communication and messaging systems. In particular, the present invention makes message delivery conditional on the mutual interest of the parties involved. As a result, the systems of the present invention are spam-free; they mitigate awkwardness and social risk in initiating certain communications; and they permit a much more flexible addressing model. Remarkably, the present invention makes communication possible between parties who would otherwise have no way of connecting.

In an aspect, the present invention provides a communication system comprising a processor that is programmed to process both a sender address and a recipient address of a first incoming message and of a second incoming message, and to deliver both messages only after finding a match (a) between a recipient address of the first incoming message and a sender address of the second incoming message, and (b) between a recipient address of the second incoming message and a sender address of the first incoming message.

In the communication system of the present invention, the processor may be programmed to process electronic mail messages, voicemail messages, SMS text messages, instant messages (IM) or even live telephone calls.

In one feature, the match in the system is programmed to be partial identicalness or full, i.e., complete, identicalness. In an embodiment, each incoming message further comprises a field of subject matter, and the processor is programmed to require a further match in the subject matter before delivery of both messages

Each recipient address may comprise one or more alphanumerical values, or a graphic value. The system may be configured to connect to a network, e.g., the internet, where the system accepts messages submitted to a World Wide Web address.

In one feature, at least one of the recipient addresses is a fuzzy address. In an embodiment, the fuzzy address comprises information known to both the sender and the recipient. For example, the fuzzy address may comprise information on an encounter between the sender the recipient, such as information on a time and a location of the encounter, clothing worn during the encounter, or a subject matter related to the encounter.

In another embodiment, the fuzzy address comprises information on the recipient's profession, the recipient's recreational activities, and so on.

In one feature, the fuzzy address comprises a narrative.

In a further feature, the communication system of the invention further comprises a mutuality database, and the processor is programmed to conclude from the match that a party mutuality exists between the two messages and records the party mutuality in the mutuality database to allow future communication delivered automatically between the sender and recipient of the two messages.

In an aspect, the present invention provides an email system that requires matching a recipient of a first email with a sender of a second email and a sender of the first email with a recipient of the second email before delivery of both emails.

In a further aspect, the present invention provides an email system that is configured to deliver a first email from a sender towards a recipient with a fuzzy address as long as the email system is able to match the first email with a second email from the recipient towards the sender.

In yet another aspect, the present invention provides a communication system, e.g., an email system, that is configured to send a user an alert when a message has been sent towards him, the alert comprising information about the sender to assist the user decide whether to accept to decline delivery of said message. In one embodiment, the information is published by the sender in a profile. In another embodiment, the information concerns a previous encounter with the user.

### BRIEF DESCRIPTION OF THE DRAWINGS

The foregoing, and other features and advantages of the invention, as well as the invention itself, will be more fully understood from the description and drawings that follow.

FIG. 1 is a flow chart illustrating steps in the operation of an embodiment of the present system.

FIG. 2 is a flow chart illustrating steps in the operation of another embodiment of the present system.

FIG. 3 is a graphic representation of how the present system delivers messages with fuzzy addresses.

FIGS. 4A and 4B are diagrams illustrating how two different users register with an embodiment of the present system respectively.

FIGS. 4C and 4D are diagrams illustrating how the two users can use the present system to reconnect with each other after learning each other's system address.

FIG. 4E is a diagram illustrating how the system delivers messages after mutuality condition is met.

### DETAILED DESCRIPTION OF THE INVENTION

Unless otherwise indicated, all terms used herein have the same meaning as they would to one skilled in the art of the present invention. It is to be understood that the present invention is not limited to the particular methodologies, protocols, and venues described, as these may vary.

Initiating communication (e.g., placing a telephone call) or sending a message (e.g., sending a paper or electronic mail) in a conventional, point-to-point system is generally a unidirectional event where information flows in one direction, from sender to receiver. Generally, the receiver is a passive entity and the delivery of a communication request or a message does not depend on the receiver's actions. Whether the receiver is willing or not, his phone rings/vibrates, or a piece of mail just “shows up” in his mailbox. For example, if Alice sends a message to Bob, as long as the system recognizes the recipient address, it will be delivered to that address, presumably Bob's, without any action on Bob's part.

Table 1 shows the situations in which messages are delivered in conventional systems. The variables t₁ and t₂ refer to the times Alice (“A”) and Bob (“B”) send their messages, respectively.

TABLE 1

| | B sends to A at t₂ | B doesn't send towards A |
|---|---|---|
| A sends to B | A receives from B after t₂ | B receives from A after t₁ |
| at t₁ | B receives from A after t₁ | |
| A doesn't send | A receives from B after t₂ | no one receives |
| toward B | | |

According to one aspect of the present invention, however, the communication systems do not execute key steps until certain conditions are met. In one feature, initiation of communication and/or message delivery in the system is conditioned on party mutuality or sender mutuality. As used herein, party or sender mutuality exists when two parties have both attempted to send a message to each other before receiving any message from the other. In looking for party mutuality, the present system assumes (and verifies, in some embodiments described in more detail hereinafter) the very act of sending a message without prompt is an indication of positive interest. The system holds a message until party mutuality is met or verified, i.e., until the system confirms that the intended recipient has also tried to send a message to the sender of the message that the system is currently processing, at which point, the system delivers both messages. The logic behind requiring party mutuality before message delivery is to condition such delivery on mutual interest, particularly, mutual positive interest. Of course, such positive interest can be temporary or only potential in nature.

Therefore, according to this feature, when a first sender sends a first message towards a first recipient, the message is not delivered automatically but held by the system instead. The default of the protocol is to hold a message. The system can be programmed to set an expiration time point for a message it holds (e.g., an hour, a day, a week, a month, a year, and so on), or it can hold it indefinitely. The holding period can be set system-wide or message-specific. In one embodiment, the system holds a message indefinitely until an event takes place, e.g., the sender's account expires or the sender has sent out the maximum amount of undelivered messages set by the system. When such an event takes place, the system either deletes all messages from that sender (in the case of membership expiration) or deletes only the oldest message from that sender to make room for the most recent message. In one embodiment, the system deletes the oldest undelivered message in its memory when the memory is full or approaches a preset percentage of capacity.

The term “towards” is used herein instead of “to” as an indication of the conditional delivery feature of the present invention. In the context of conventional communication systems, “sending to” indicates an assumption that the communication, e.g., a message, will arrive at the destination unless some exceptional circumstance occurs. In the present conditional communication and delivery system, it is appropriate to change the terminology where a message is not directly sent to its destination, but towards the destination. The act of sending the message brings the message closer to being delivered, but does not guarantee that the delivery will actually happen.

In one embodiment, party mutuality is permanent or persistent until one party takes action to block the other party, i.e., once party mutuality is established, the system will memorize this mutuality to allow future communications between the two parties to flow according to the conventional, non-conditional delivery mode. In an alternative embodiment, party mutuality is temporary or transient, and it must be re-established upon every message exchange; in other words, the mutuality is message-specific. To aid parties in continuing their communication, users of the system are encouraged to include some form of the sender's traditional contact information in messages they submit to the system. Once the message is successfully delivered, the recipient can use that information to contact the sender outside the present system.

The same inventive feature also applies to initiation of live communications. For instance, A dials B's telephone number or inputs B's id using a voice-over-internet-protocol (VOIP). The present system will hold that call until B also attempts to talk to A by either dialing A's number or inputting A's id using VOIP. At that point, A will be connected with B for live conversations.

Table 2 shows the situations in which message delivery occurs in a system according to the present invention, where t₁≦t₂:

TABLE 2

| | | B doesn't send |
|---|---|---|
| | B sends towards A at t₂ | towards A |
| A sends towards B | A receives from B after t₂ | no one receives |
| at t₁ | B receives from A after t₂ | |
| A doesn't send | no one receives | no one receives |
| towards B | | |

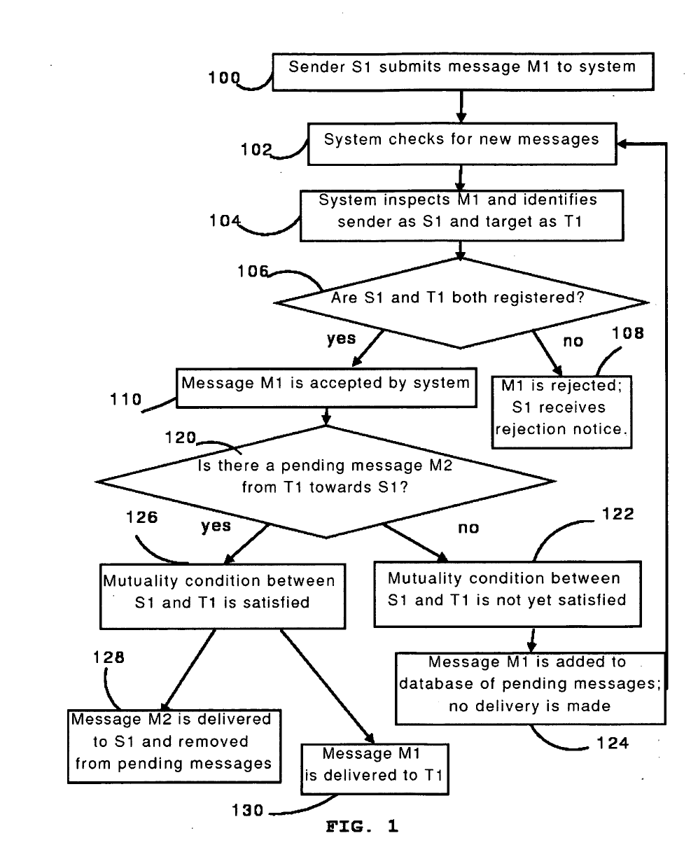

FIG. 1 is a flow chart that illustrates how one embodiment of the present system works. In step 100, a sender S1 submits a message M1 towards an intended recipient T1. In step 102, the present system checks for new incoming messages and identifies message M1. In step 104, the system inspects message M1 and identifies S1 as the sender and T1 as the intended recipient, or target. In step 106, the system consults its registration database to see if both S1 and T1 are registered users. If the answer is “No,” which can be because between S1 and T1, one of them or both are not registered users, then the system executes step 108, which is to reject message M1 and to send a rejection notice to sender S1. The rejection notice, in one example, tells S1 why the message has been rejected, i.e., which party is not registered with the system. In one embodiment, the system may have imposed restrictions on content of the communication, e.g., on offensive or sexually explicit language or image, and may have rejected the message for that reason. In that embodiment, the system informs S1 of the reason for rejection in the rejection notice, and optionally suggests a remedy. If S1 remedies the message, he can go back to step 100 and re-submit the revised message.

If the answer to the system inquiry in step 106 (“Are S1 and T1 both registered users?”) is “Yes,” then the system proceeds down the side of step 110, and accepts the message M1. Next in step 120, the system consults its pending message database to see if there is a pending message M2 that is from T1 towards S1, i.e., a message between the same parties in the other direction. If “no,” the system concludes, in step 122, that mutuality condition, or a match, between S1 and T1 is not yet satisfied. In step 124, message M1 is added to the database of pending messages, and no delivery is made. And the system loops back to step 102 where it checks for the next new message, and a new M1 progresses through the chart.

If the answer to the question in step 120 (“Is there a pending message M2 from T1 towards S1?”) is “yes,” then the system proceeds to step 126 and concludes that mutuality condition, or a match, between S1 and T1 is satisfied. Consequently, mutual delivery is initiated: in step 128, pending message M2 is delivered to S1 and, optionally, removed from the database of pending messages; in step 130, message M1 is delivered to T1, and, optionally, removed. Steps 128 and 130 can occur simultaneously or sequentially with either step being executed by the system first.

The present system can be programmed to include additional requirements in order for it to find a mutuality condition satisfied in step 126 illustrated in FIG. 1. Some examples are hereby discussed where part of the requirements for meeting the mutuality condition may include:

(a) Timing: e.g., S1 and T1's messages must be sent within a preset time period, say, an hour of each other;

(b) One or more topics: in order for the condition to be satisfied, S1 and T1's messages must have the same topic designation. The system may require a user to designate the topic of each message by choosing from a few preset fields, e.g., business, romance, friendship, gossip, entertainment, sports, hobby, news, etc., in the subject matter line. Requiring topic mutuality as part of the mutuality condition for communication ensures that not only the parties wish to communicate to each other, but also on the same topic. This avoids some potentially embarrassing or relationship-damaging situations where one party misreads the other and ventures into a topic that the other party is not ready or willing to discuss, such as romance;

(c) Content: kind of an extension of the topic requirement, in order for the mutuality condition to be satisfied, the content of S1 and T1's messages must meet a similarity or compatibility criterion. For example, the system may scan the message bodies for occurrences of certain keywords in both messages. In one embodiment, the users get to designate keywords for their respective messages before submitting them to the system and the system will then look for mutuality in those keywords;

(d) Profile: in this case, system users are asked to create profiles describing their attributes and interests. In order for the mutuality condition to be met, S1 and T1's profiles must meet a similarity or compatibility criterion set in the system.

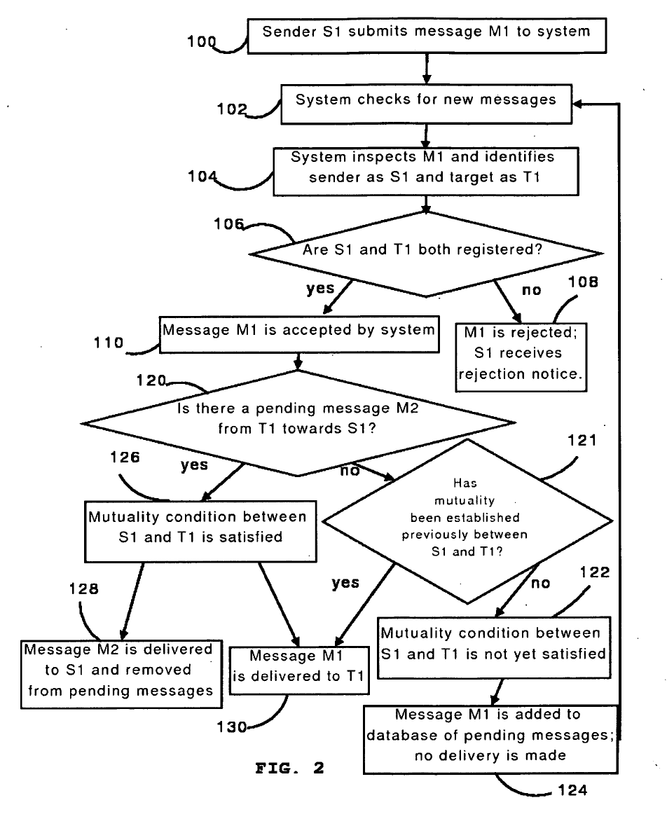

In one feature, mutuality condition only has to be satisfied once or for a preset number of times (e.g., 3 times) for the system to deliver all ensuing communications between the two parties. In other words, the system constructs a mutuality database to memorize party mutuality that has been established. Referring now to FIG. 2, in an embodiment with such feature, the system processing steps are largely the same as those illustrated in FIG. 1, except that after the system answers “no” to the question posed in step 120 (“Is there a pending message M2 from T1 towards S1?”), the system further consults, in step 121, the mutuality database to see if mutuality has been established previously between S1 and T1. If the answer is “Yes,” then the system proceeds to step 130 where the message under examination, M1 is delivered to its intended target T1. If the answer is “No,” then the system proceeds to steps 122 and 124 as in FIG. 1, whereby no delivery is made in this round.

In another feature, the present system is used in conjunction with a more conventional communication system. For example, as described above, if the present system is programmed to accept permanent mutuality, i.e., mutuality between two parties only needs to be satisfied once and is recorded for all future communications, the present system basically reverts to the more conventional email system for ensuing message deliveries which are instant and unidirectional. In another example, the present system allows a user opt out of the mutuality requirement. This offers the user the chance of receiving “surprise messages” from less familiar sources when such messages become desirable under certain circumstances, e.g., when the user reasonably anticipates certain important messages. For example, when a user has lost her cat and is hoping that someone would contact her after reading her user identity on the tag that the cat wears. In a further example, the present invention sends an alert or similar signal to a registered user of the system with regard to an unsolicited message if the user has agreed to such alerts. In an embodiment, the alert provides some information on the sender of the message or the message itself to help the user decide if he wants to accept this unsolicited message.

The present invention has numerous advantages over a more conventional system. First, because the present system requires a mutuality condition be satisfied before it facilitates communication between two parties, it radically reduces unsolicited communications including spams that clutter up our conventional communication systems including the email and voicemail systems. The only way a user could get a message from others that he does not want to communicate with is if the user was unwise enough to send them a message, perhaps by accident. The system has at least two ways to combat such accidental communications: first, the system can be programmed to impose transient mutuality, i.e., mutuality conditions have to be established each time a message is sent—the user get at most one unwanted message this way. Second, in the embodiments where mutuality is permanent or persistent, the system can allow a user to block a specific party, either preemptively or after receiving a message through removing himself and the sender as a recognized pair from the system's mutuality database to block future communications. All this is possible because in the present system, communication is a privilege and not a right. People guard their conventional contact information for fear of getting inundated by spams—blocking senders in the conventional email system, for example, is not effective when the spammer keeps changing his email address. In the present system, in contrast, a user no longer worries about giving out his user identity for fear of getting spammed.

The possibilities for unwanted communications are further reduced when the system enforces mutuality requirements in addition to the basic party mutuality. For example, if topic mutuality is required, Alice might send Bob messages on a variety of topics, some of which he wants to discuss and some of which he does not. However, if he receives Alice's message about romance, it could only be because he sent her a message about the romance as well. The fact that he sent a message on that topic is presumed by the present system as evidence of his interest in discussing the topic.

While freedom from unwanted communications and messages is a benefit from the recipient's standpoint, the present systems also offer an important benefit from the sender's standpoint. A second major advantage of the present system is that its users are freed from the social risks and consequent awkwardness that people often experience when they initiate communications. People hesitate to initiate a conversation because they are unsure of how the gesture will be received: Does the other person want to talk with me about this topic or will it be an imposition? Does that person want to talk about it right now? Will I reveal too much by initiating the conversation? Will I damage our relationship? Will I be rejected or ridiculed?

An example of this situation is dating. The awkwardness of asking someone out boils down to uncertainty about the other party's interest level. Initiating a romantic conversation also risks damaging existing relationships, whether platonic friendship or business relations. The present system provides a way to send a romantic message to a person, with a guarantee that the message would only be delivered if the person indeed is interested in going out. By using the present system that imposes topic mutuality or match, Alice no longer has any reason to hesitate in sending Bob an email on the topic of dating, because he will only receive it if and when he tries to communicate with Alice about dating as well. If Bob does not attempt to communicate about dating with Alice, and even if he does attempt to communicate with her on other topics, he will never receive the message on dating or become aware that Alice ever attempted to send such a message.

There are a host of other scenarios where the present system can reduce the awkwardness experienced in everyday life. Some non-limiting examples include:
two competing scientists who would like to collaborate on a highly specialized project, but only if the other party has already thought about the project and has started studying it;
two disgruntled parties who would like to propose reconciliation after an argument, but only if the other person is also interested in reconciliation;
an employee who would like to transfer to another division in a large company, and a manager who would like to absorb him, but only if each party is already interested and would keep the transfer confidential until it was formalized; and
two observers of wrongdoing in an organization, who would consider being whistleblowers, but only if they could enlist each other's discreet assistance;
a couple who might like to separate but only if the interest is mutual (opposite of the dating situation described above).

### Address

In a conventional messaging system, the system must examine the address on the message and use the information it contains to route the message all the way from sender to recipient. In general, when a messaging system is processing a message from Alice to Bob, the address on Alice's message to Bob must uniquely identify the destination (Bob) and must be feasible for the messaging system to interpret.

In the system of the present invention, however, the system can now rely on the fact that a delivery must be made only when two messages exist in the system, originating at opposite endpoints. Hence, the address on any one message does not need to contain enough information or information of enough specificity to route the message all the way to the target. It merely needs to have enough information to be matched with a message moving from that target towards the sender.

Accordingly, the present system enables an important inventive feature where messages with fuzzy addresses can now be delivered. The present system can now hold a message from a sender with a fuzzy and otherwise undeliverable recipient address, waiting for a matching message from the yet-to-be-identified recipient towards the sender. When it identifies a match between such two messages, i.e., that they satisfy the preset mutuality condition, the system now has enough information to complete the delivery of both messages. Each message should be routed to the sender of the other message, and since a message typically has a concrete return address, the system can easily contact the sender with a message that is intended for the sender. Two messages that might not have been deliverable in isolation become deliverable when matched. In a way, the messages “help” each other get delivered.

To aid matching of messages with fuzzy recipient addresses, each sender needs to provide a way of identifying himself besides the user identity registered with the system. For example, if the sender describes an intended recipient according to a particular format, the sender may want to describe him- or her-self in the same or a similar format. In one embodiment of the present invention, the system provides a preset format with preset fields for a sender to fill in for a particular subject matter. For example, when user Alice logs into the present system and chooses to compose a new message M1 intended for Bob, the system gives Alice the following choices: Alice can input at the recipient field either a unique address or a fuzzy address. A unique address is one that is either registered with the present system (e.g. the moniker “Banana” chosen and registered by Bob) or with a conventional email delivery system (e.g., Bob@hotmail.com). A fuzzy address, however, is not a unique identifier that the system readily recognizes; instead, it consists of descriptive words, alphanumeric values, and so on.

In one example, a fuzzy address consists of a narrative that describes Bob, the first intended recipient of the message M1, e.g., a narrative of a past encounter with Bob (“Bob at Jean's party on May 1, 2008, was wearing turquoise Converse sneakers”) or a narrative of Bob's position, title, reputation and other characteristics commonly used to identify a person (“the CEO of the largest publishing company in Wisconsin” or “the leading expert at Harvard on Qing Dynasty pottery”).

In an alternative example, the system provides a format that consists of several fields for the first sender Alice to fill out in an effort to streamline or provide as much structure as possible to the address. The format can be topic-specific and, if so, shows up on the computer screen after Alice picks one of the prompted topics. For example, if Alice picks “romance,” the system may asks her to fill out fields related to a past encounter with Bob, such as: the time, the place or location, the first name, the last name, the gender, the race, the ethnicity, the height, the hair color, the hair length, the color of an upper body garment, the color of a lower body garment, any particularity about B or the encounter, and so on. Of course, the system may be programmed to ask Alice to fill out all or some of these fields and/or other fields, some or all of which may be required fields. As a further example, if Alice picks “business” as the topic of message M1, the system may ask her to fill out fields related to Bob's business or job, such as: title, company, location, industry, and so on.

Once Alice filled out prompted fields to describe Bob, the system further asks her to describe herself using the same format in expectation of a fuzzy address for Alice in a message M2 originated by Bob. If Alice's profile with the system contains information previously filled for any of the fields, the system may autofill those fields while giving Alice an opportunity to modify the answers.

When Bob accesses the present system, say, through the Internet, to submit a message M2, he will go through a similar process. Notice Bob does not have to be a registered user of the present system, as long as he provides a unique return address (e.g., a conventional email address), although the system can certainly require all users to register first. Notice also Bob may use a unique system address of Alice (e.g. the moniker “Apple” chosen by Alice and registered in the present system) in M2, but for M2 to match with M1, Bob needs to either (a) anticipate that Alice might use a fuzzy address for him, say, because he knows that he never gave her his user identity, and thereby fills out an applicable fuzzy address format describing himself; or (b) become a registered user of the system and fill out a profile of himself and rely on the system to locate him when it searches profile database for a match to Alice's description.

When the present system receives the second message M2 from Bob addressed towards Alice, possibly using a fuzzy address, if it is able to match it with M1, it will deliver M2 to Alice's return address and M1 to Bob's return address.

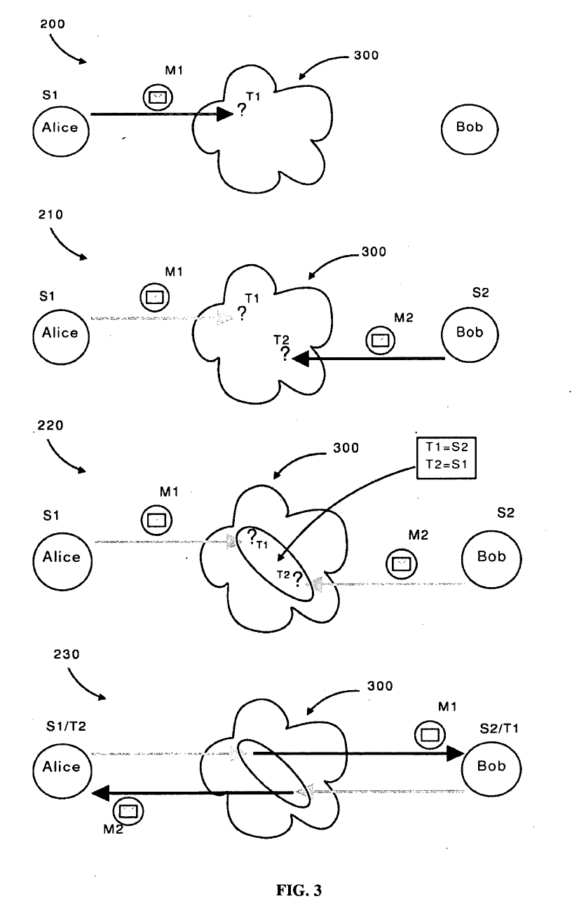

FIG. 3 illustrates the way the present system works with fuzzy addresses. In step 200, a first sender S1 (Alice) submits to the present system 300 a first message M1 with a fuzzy address towards a first target recipient T1 (Bob). The system holds the message M1 without delivery. In step 210, Bob, acting as a second sender S2, submits to the present system 300 a second message M2 with a fuzzy address towards a second target recipient T2 (Alice). In step 220, the system 300 processes M2 and was able to match it with M1 by recognizing that T1=S2 and T2=S1 despite the fuzzy addresses for T1 and T2. Seeing that mutuality conditions have been met for message M1 and M2, the system 300, in the next step 230, delivers M1 to Bob using S2's unique address and M2 to Alice using S1's unique address.

As described above, one form of a fuzzy address is more or less a narrative that tries to describe the intended recipient. For example, Alice may write in free English prose of an encounter in a message M1 intended for Bob:
To the handsome guy who stepped on the 1 train at 23^{rd} St. in NYC at 5 pm on May 23, 2007. He was wearing turquoise Converse sneakers and I had on my brown Birkenstocks.

Meanwhile, Bob writes, also in prosaic style about the same encounter in a message M2 intended for Alice:
To the gal wearing crunchy sandals who looked at me when I got on the 1 at 23rd, 5ish, last Friday. I was wearing light blue pants with matching sneakers.

In order to match the two messages M1 and M2, in one embodiment, the present system does not attempt to “understand” what either message says, but instead tries to match words and phrases common to both messages. In one feature, the present system extracts time information (t) and location information (p) from a message and creates a tuple that equals (t, p) for the message. The system then compares this time- and location-based tuple value to those of other messages until it finds a match. The system then examines the other words used in the fuzzy addresses to see how many words or what percentage of words match. In the above example, the system is able to first match M1 and M2 according to their time- and location-based tuples: both mention “23^{rd} [Street]” and although Bob's M2 does not indicate which city it was, from his profile, the system assumes he was in his home city New York city. And the timestamp of Bob's message M2 tells the system that “last Friday” was May 23, 2007 mentioned in Alice's message M1 and the processor is able to match “5ish” in M2 with “5 pm” in M1.

In the next step, the system scans the rest of the addresses of M1 and M2 to see if there are further matching keywords. In an embodiment, the system is equipped with a dictionary, a thesaurus, an encyclopedia, and access to other useful reference sources including websites and search engines such as “Wikipedia.com” and “google.com” for this purpose, and is able to match “turquoise Converse sneakers” in M1 with “light blue . . . sneakers” in M2, and “brown Birkenstocks” in M1 with “crunchy sandals” in M2.

In another embodiment, the system asks each user to put time and location information in message fields labeled as such, so that the process does not have to extract this information from a general narrative. In an optional feature, the processor provides common terms from a common dictionary to limit variations in describing the same thing.

Once the address match between M1 and M2 is identified, the system routes each message to the sender of the other message (as identified in the return address). So, Bob gets M1 and Alice receives M2.

The above examples using fuzzy address schemes highlights another advantage of the present invention, namely, the privacy and anonymity provided by the present system in comparison to a public broadcasting system. All of the communications that Alice and Bob have engaged in using the present system, whether via unique addresses or fuzzy addresses, have adhered to the point-to-point model of messaging. Messages have been exchanged directly between recipients (ignoring any intermediate routing steps that happen at a low level). Messages have never been broadcast in public forums or exposed to any recipients other than the specific ones intended.

The narratives that Alice and Bob respectively wrote as their fuzzy addresses above is reminiscent of postings that are sometimes made in public forums (personals in local newspapers and online) where a person can try to reconnect with someone they encountered. The hope is that if the person happens across the description of the encounter and recognizes it, he or she will contact the author of the post. These broadcast forums have several disadvantages: they are often cluttered with superfluous posts, they require that the poster expose the details of the encounter to the world (even if the poster can remain anonymous), they require that the poster make his or her interests known to a party who might not reciprocate them, and they invite spam responses from people who were not actually present at the encounter. In using the present system, however, neither Alice nor Bob suffers any of these problems. Their messages are kept private until mutuality conditions are met, at which time the messages are delivered to the intended recipient only.

Another application of the anonymity feature of the present invention is in the job-searching and recruiting world. For a job candidate who is currently employed, there is much risk in making it public of the candidate's interest in a new job or position inside or outside the current employer. Our system will allow such candidate to explore opportunities out there in an anonymous manner. The candidate may even communicate with potential employers directly without the aid of professional recruiting agencies or job posting centers like Monster.com.

Because of the way messaging systems work today, many people assume that if they don't have a concrete address for their intended recipient (and can't find it in searching public information), they must resort to a broadcast forum to get their message across. The present invention turns that assumption on its head. In the present messaging systems, a user can still have the advantage of point-to-point style communication, even with incomplete addressing information, as long as there's mutuality.

In the present system, a workable address no longer needs to identify uniquely the intended recipient but simply have a high probability of matching an address supplied by the recipient. The quality of the addressing scheme according to the present invention is dependent on:
1. the choice of what information goes into an address;
2. the specific format used for representing that information (including dictionaries for common terms); and
3. the matching strategy applied by the system.

Again, the problem of matching information is generally easier than the problem of understanding it, and so the matching system need not be particularly sophisticated in a semantic sense. Accordingly, the present system aims to include information that is shared by the communicating parties in order to increase the chance of correctly matching messages with fuzzy addresses while avoiding mismatches. In one feature, the present system is programmed to take into account the following factors when deciding what kind of shared information it should ask users to include in a fuzzy address:
A. who the parties are;
B. how the parties know (or know of) each other; and
C. what topic or subject matter they are communicating about.

Examples of some categories of shared information that the present system may be programmed to include are:
shared information about the parties themselves (physical description, personality description);
shared information about a common external circumstance (this could be the details of a specific encounter, or an event observed by both parties even if they never met);
shared information about a topic or subject matter (scientific research, etc.); and
description of a shared intent, purpose, and/or thought.

In one embodiment, a sender could address a message to someone who shares a specific piece of information, without knowing a priori that such a person even exists. If there are in fact multiple parties who share that information, the system could support group-style communication, where all messages with matching addresses will be forwarded to all senders (all parties who have proved, by sending a message with a matching address, that they possess the information in question).

Some examples of specific addressing schemes according to the present invention are:
1. An addressing scheme for helping parties reconnect after an encounter in the physical world. The address could consist of the following elements: time, location, description of A's clothing, description of B's clothing. The descriptions could consist of words taken from a common dictionary made available in a public forum such as the Internet.
2. A simplification of the above scheme for people wearing nametags or garments with text on them. The address could consist of: text on A's tag or garment, text on B's tag or garment.
3. An addressing scheme for helping parties reconnect after a discussion. The address could consist of the three most unusual words from their conversation. These words could be agreed upon near the end of the conversation or simply inferred by each party based on his or her memory of the conversation. Partial matches could be allowed in a case where parties pick some but not all of the same words.
4. A stricter version of the above scheme that works for people with excellent memories. The address would consist of a verbatim transcript of their conversation (or some prefix thereof). Each party would have to transcribe it similarly.
5. An addressing scheme for helping witnesses of a common event reconnect. The address could consist of: time, location, event type, outcome. Again, these elements could be taken from a common dictionary.
6. An addressing scheme for helping old friends locate each other. The address could consist of A's name, B's name, time/location of first meeting, time/location of most recent meeting. The times could be provided as ranges which would have to overlap for the addresses to be considered a match.
7. An addressing scheme for helping researchers working on similar problems connect. The address could consist of: research field, research subfield, list of three most relevant papers.
8. The address could be free form prose describing any kind of information. Addresses could be matched using statistical text similarity metrics.
9. The content of the message could be treated as the address. As above, message bodies could be compared using similarity metrics.

According the present invention, any ontology and description framework can be plugged into the system and used as a basis of addressing, as long as both parties know what format to follow. In one embodiment where the system is implemented as a web-based service, the instructions and dictionary may be made public. The instructions could be provided and the users left responsible for building addresses on their own, or there could be a user interface that gathers the relevant information through a question and answer process, and then assembles it into a canonical format. Different addressing formats could be used in the same system, as long as each address has a format qualifier.

Features of the present invention are further illustrated by the following non-limiting examples. The messages described in the examples could be any kind of communication: emails, instant messages, SMS text messages, or postal letters, and so on. A single equals (=) is used to indicate a definition and a double equals (==) to represent a boolean test for equality.

### EXAMPLE 1

### Simple Party Mutuality

This example illustrates the simplest form of a messaging system where delivery is conditional on party mutuality. A message is represented as a tuple m=(s, d, b) where
s is the address of the sender of the message
d is the address of the destination or intended recipient of the message
b is the body of the message

In this example, we assume that the sender addresses and the destination addresses adhere to the same format and can be directly compared with each other for equality. Furthermore, we assume that all addresses are concrete, meaning that they contain sufficient information for the message processor to identify the location they represent and route a message to that location.

Our message processor maintains a data structure containing messages that have been submitted for processing, but not yet delivered. We call this data structure WaitingMessages. It could be programmed as a list, array, or any other structure that allows items to be added and retrieved and queried.

The behavior of the message processor is encapsulated in a procedure called processMessage, defined below.

```
processMessage:
when handling an incoming message m₁ = (s₁, d₁, b₁), do the following:
    if there exists a message m₂ = (s₂, d₂, b₂) in
WaitingMessages where s₂ == d₁ and s₁ == d₂
    then
            remove m₂ from WaitingMessages,
            deliver m₁ to d₁
            deliver m₂ to d₂
    else
        add m₁ to WaitingMessages
    end
```

### EXAMPLE 2

### Simple Party Mutuality With Fuzzy Addresses

In this example, we introduce the notion of a fuzzy destination address (i.e., recipient address). We represent a message as a tuple m=(s, d, b) as before. We continue to assume that the sender address s is concrete, but we no longer assume that the destination address d is concrete. We allow d to be fuzzy, meaning that it does not uniquely and unambiguously identify a location where the message should be delivered. The message processor is no longer able to execute a command like “send m to d.”

In this example, the destination addresses may obey an entirely different format from the sender addresses. For example, the destination address could be a description of an encounter between the sender and the intended recipient of the message. This address might adhere to a format like d=(t, p, sn, rn) where
t is the time of the encounter, expressed as MM DD YYYY HH
p is the place or location of the encounter, expressed as a zipcode
sn is the first name of the sender
rn is the first name of the receiver
   It is assumed that the existence of a procedure called match that accepts two destination addresses d₁ and d₂ and returns true if and only if:
the receiver identified in d₁ matches the sender identified in d₂
the receiver identified in d₂ matches the sender identified in d₁
the common information in d₁ matches the common information in d₂
   For example, in the addressing scheme described above, match(d₁, d₂) would return true if and only if:
receiver name rn₁ matches sender name sn₂
receiver name rn₂ matches sender name sn₁
the times t₁ and t₁ are the same
the zip codes p₁ and p₂ are the same

The message processor works as follows:

```
processMessage:
when handling an incoming message m₁ = (s₁, d₁, b₁), do the following:
        if there exists a message m₂ = (s₂, d₂, b₂) in
        WaitingMessages where match(d₁,d₂) ==
true  then
                remove m₂ from WaitingMessages,
                deliver m₁ to s₂
                deliver m₂ to s₁
        else
            add m₁ to WaitingMessages
        end
```

Note that a key difference between this and Example 1 is that the message processor uses only the sender addresses when delivering messages and does not attempt to deliver to the fuzzy destination addresses.

### EXAMPLE 3

### Complex Party Mutuality With Fuzzy Addresses

In this example we build on the previous examples, showing how more complex criteria can be introduced into the decision process for message delivery.

We assume that every message sender, identified by an address s, has a profile p associated with it. This profile includes arbitrary personal information about the sender such as taste in music, dating interests, business skills, etc.

In this example, we no longer use a boolean method for matching addresses, but instead assume a method called addressMatch that returns a percentage value indicating the quality of the match.

We assume the existence of a function called profileMatch that accepts two sender profiles and returns a percentage value indicating the quality of the match.

We assume the existence of a function called topicMatch that accepts two message topics and returns a percentage value indicating the quality of the match.

We assume the existence of a function called bodyMatch that accepts two message bodies and returns a percentage value indicating the quality of the match.

We assume the existence of a function called timeMatch that accepts two message bodies and returns percentage value indicating the quality of the match.

In each of the above cases, the actual process for computing the quality of the match is arbitrary and can be implemented a variety of ways.

A message is represented as a tuple m=(s, d, b, tp, ts, e, c) where
s is the address of the sender of the message
d is the address of the intended recipient of the message
b is the body of the message
tp is the topic or subject of the message
ts is a timestamp indicating when the message was sent
e is a timestamp indicating the expiration date of the message
c is a list of criteria or thresholds that determine when this message should be treated as matching another message. This list includes a threshold value for each of the matchable elements in the message, including d, b, tp, and ts, as well as p which is not included in the message.

We adopt the convention that pi represents the profile of sender sᵢ and assume that the message processor can access the profile for any given sender.

```
processMessage:
when handling an incoming message m₁ = (s₁, d₁, b₁, tp₁, ts₁, e₁, c₁),
do the following:
    if there exists a message m₂ = (s₂, d₂, b₂) in WaitingMessages where
                profileMatch(p₁, p₂) meets the thresholds in c₁ and c₂
                addressMatch(d₁, d₂) meets the thresholds in c₁ and c₂
                topicMatch(tp₁, tp₂) meets the thresholds in c₁ and c₂
                bodyMatch(b₁, b₂) meets the thresholds in c₁ and c₂
                timeMatch(ts₁, ts₂) meets the thresholds in c₁ and c₂
                expiration date e₁ is in the future
    then
            remove m₂ from WaitingMessages,
            deliver m₁ to s₂
            deliver m₂ to s₁
    else
        add m₁ to WaitingMessages
    end
```

### EXAMPLE 4

### Simple Party Mutuality With Virtual Gifts

The system in this example requires simple party mutuality with concrete addresses as in Example 1. However, the system here allows senders to attach virtual gifts to their messages. A virtual gift contains some content like a static image, animation, coupon code, or password for use in an online game. A virtual gift also has a price. This price must be paid by the sender of the message if and when the message is delivered, but not before.

A message is represented as a tuple m=(s, d, b, g) where
s is the address of the sender of the message
d is the address of the intended recipient of the message
b is the body of the message
g is a virtual gift associated with the message; this is an optional field and may be empty

```
processMessage:
when handling an incoming message m₁ = (s₁, d₁, b₁, g₁),
do the following:
    if
      there exists a message m₂ = (s₂, d₂, b₂, g₂) in WaitingMessages
      where s₂ == d₁ and s₁ == d₂
    then
            remove m₂ from WaitingMessages,
            if g₁ is not empty, charge sender s₁ for g₁
            if g₂ is not empty, charge sender s₂ for g₂
            deliver m₁ to d₁
            deliver m₂ to d₂
    else
        add m₁ to WaitingMessages
    end
```

### EXAMPLE 5

### Whimwords Construct

In an application of the present invention, called the Whimwords system, participants register transient aliases and display them visually; for example, on a nametag a piece of clothing or a fashion accessory. The registration process establishes a password for the alias. The message processor maintains a mapping between the aliases and the concrete addresses of each participant. Messages in this system do not contain concrete addresses for the sender or recipient, but only the aliases of the sender and recipient.

A message is represented as a tuple m=(sa, da, b) where
sa is the alias of the sender of the message
da is the alias of the intended recipient of the message
b is the body of the message
   It is assumed that when a message is submitted to the system, the password for the sender alias is also supplied.

```
processMessage:
when handling an incoming message m₁ = (sa₁, da₁, b₁)
and accompanying password p, do the following:
    if p is not the proper password for sa₁
    then drop m₁ and stop
    if
      there exists a message m₂ = (sa₂, da₂, b₂) in WaitingMessages
      where sa₂ == da₁ and sa₁ == da₂
    then
            remove m₂ from WaitingMessages
            lookup concrete address for sa₁ and call it c₁
            lookup concrete address for sa₂ and call it c₂
            deliver m₁ to c₂
            deliver m₂ to c₁
    else
        add m₁ to WaitingMessages
    end
```

### EXAMPLE 6

### Whimwords in Use

In an embodiment, Whimwords can be a messaging system built with some or all of its features as follows:
User name or address has at least one alphanumerical value, and can be a combination of any words, phrases, numbers, symbols, or other string of characters, with or without restrictions. A user can therefore pick an address that tells others something about the user, e.g., his character, origin, or interest, while keeping the address relatively easy to recall. The system, in one embodiment, even allows a user to include a graphic value in the address. Characters, letters and symbols that appear in languages other than English is also contemplated in implementing the present invention. The system may impose certain restrictions in what can be used to construct an address. For example, the system may disallow the use of space in the user name or address. Some examples of user name/address include: “booth babe” “bug” “Taichi master” “piano lover” “Bostonian” “2QT2BSTR8” and so on.
A user communicates his address to others by displaying it visually (i.e. wearing it on a nametag) or informing people directly, e.g., telling it to people in conversations.
In one implementation, addresses are transient, you keep yours for a short period of time, a couple of days or weeks, after which it becomes free for others to use. Or as a preferred member, for a longer period, e.g., as long as the member remains in good standing.
User names or addresses must be registered and are password protected; you need a password to send a message from a given address.
The system enforces address uniqueness; two people cannot simultaneously register the same address.
Registration and messaging can be done via SMS text messages sent from a cell phone, or on through the Whimwords website.
Message delivery is conditional on sender mutuality. In one embodiment, the mutuality can be relaxed, e.g., if a user chooses to accept, the system may send an alert message to the user when a message has been sent towards the user.

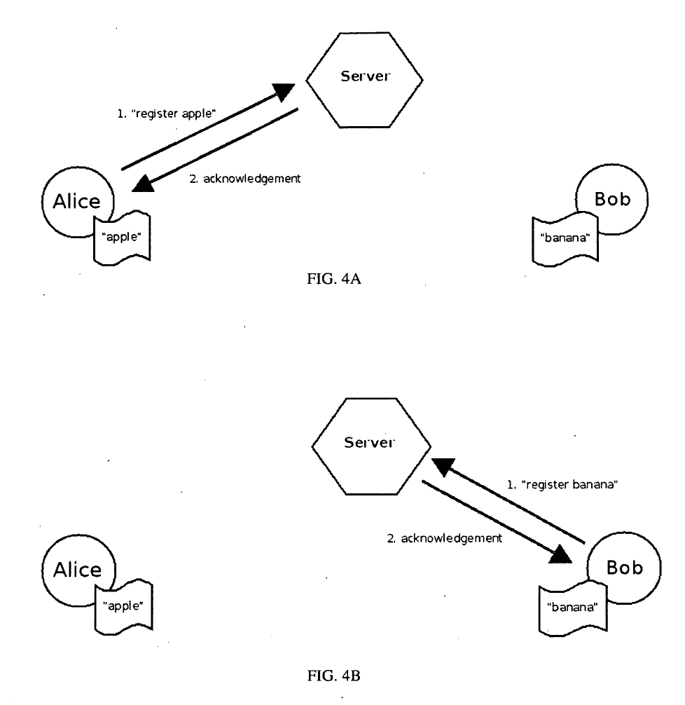

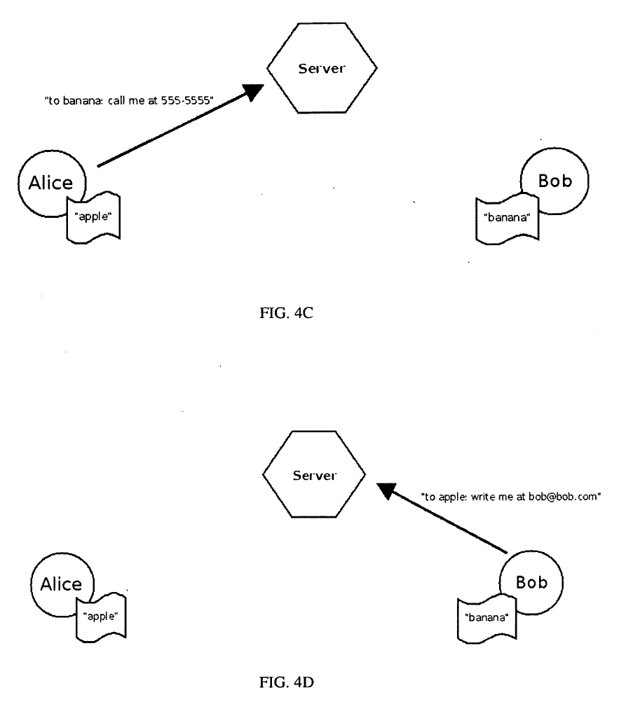

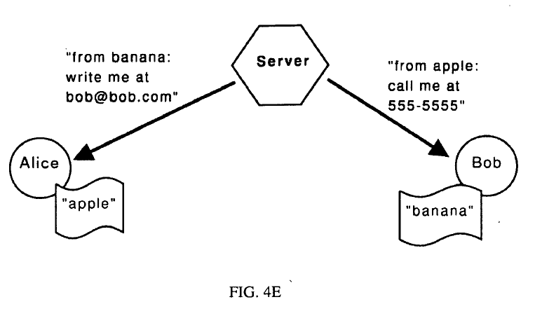

How this system would work in practice is now described in further detail. Say Alice decides to wear a nametag that says apple and Bob decides to wear a nametag that says banana. Referring to FIG. 4A, Alice sends a message to the Whimwords server indicating that she wants to register apple as her identifier. She could send this message as an SMS text message from her cell phone, or she could use the Whimwords website. She receives an acknowledgment saying that the registration was successful and including a password that she will need when she later sends a message under the identity “apple.”

Referring now to FIG. 4B, Bob completes the same registration process for his word “banana.”

Now Alice and Bob encounter each other and notice each other's tags. After the encounter, Alice remembers that she wants to reconnect with “banana” and Bob remembers that he wants to reconnect with “apple.” Note that the two might not have actually revealed their real names to each other yet. Also, while it is easiest to see how this scenario would work if the two wear nametags or some other visual display of their words, they might also simply reveal the word in conversation and not display it visually.

In FIG. 4C, Alice sends a message towards “banana” including the contact information she would like that person to use to get in touch with her. As with the registration message, this could be sent from Alice's cell phone or could be sent from the website. It is not illustrated in the diagram, but Alice needs to establish herself as the current owner of the “apple” identifier before the message will be accepted. She does this by supplying the password provided upon registration (however, if she is sending the message from her cell phone, this requirement can be waived because her cell number, which would have been detected during registration, establishes her identity). The Whimwords system holds the message at this point and does not deliver it to Bob because mutuality has not been established yet.

Referring now to FIG. 4D, Bob now sends a message towards “apple,” including his preferred contact information.

Referring now to FIG. 4E, after Bob sends his message, mutuality is established between him and Alice, so the system delivers Alice's message to Bob and vice versa. If Alice and Bob had sent their initial messages over SMS, these messages would also be delivered to them via SMS.

In an alternative embodiment, the mutuality requirement is relaxed. For example, the system may send a user an alert when a message has been sent towards him, the alert comprising information about the sender to assist the user decide whether to accept to decline delivery of said message. In one embodiment, the information is published by the sender in a profile. In another embodiment, the information concerns a previous encounter with the user.

Other features that may be made available by the system include:
At a website, e.g., the whimwords.com website, users are able to send new messages and view the histories of all messages they have sent and received;
Users can exchange a limited number of followup messages directly without re-establishing mutuality;
users can log onto the website and search for other whimwords, checking whether those whimwords are in active use in the system, and viewing public information associated with those whimwords
users can log onto the website to update their cell phone numbers, email addresses, passwords, and other preferences.

### EXAMPLE 7

### Whimwords Text Messaging System

The Whimwords application was set up to receive SMS text messages sent by mobile phone to designated shortcode. In the example that follows, we assume the shortcode 32075; however, the particular shortcode is not significant to the workings of the system.

Users used the text messaging capability of their mobile phones to send commands to the Whimwords system. A new user can reserve a Whimword, and an existing user can send a message “towards” another user, all via text messaging. For example, to reserve the Whimword “apple,” a user would send a text message to 32075 with the following body:
“whim r apple”

In this message, “r” indicates that the user is reserving a word, and apple is the particular word that is being reserved.

After sending this message, the user would receive a text message back from the Whimwords system. If “apple” was available and the registration could be completed, the user would receive a text message similar to this:
Registration successful. Your whimword: ‘apple’. Password 4
whimwords.com: yu739r29d. 2 whim someone, text ‘WHIM theirWord yourMessage’. Omit spaces in theirWord.

At this point, the Whimwords system would associate the user's mobile phone number with the identifier “apple”. The temporary password allows the user to log onto the Whimwords website as “apple” and manage the account. In particular, the user can change the password after logging in.

If “apple” was not available, the user would receive a text message similar to the following:

Apple is not available. Try reserving another word.

Let's say registration was indeed successful and user A now owned the Whimword “apple.” If A would like to send a message towards another user who's Whimword is “banana,” A would send the following text:

message to 32075:
whim banana

Above, A did not specify any custom content to be sent to banana, so the system would send a “default” message towards banana on A's behalf. The default message may look like this:

From ‘apple’: contact me at 617 347 4459

In this case, 617 347 4459 is the cell # from which A registered Whimword “apple.” Of course, Banana would not receive this message automatically. Banana would only receive it if and when mutuality was established.

In an alternative example, the default message reads as follows:

From ‘apple’: Hi . . . (To reply, text your message like this: ‘whim apple yourMessage’)

If A did not want the system to send the default message, e.g., the one with her cell phone number, to Banana, but instead wanted to specify a custom message, A could send a message like the following to 32075:

whim banana Hi there. Email me at alice@gmail.com

In this case, A is telling the system that she wants Banana to receive the message “Hi there. Email me at alice@gmail.com.” Again, Banana would only receive this message if and when mutuality was established.

Once A has sent the “whim s banana” message, she would get a response back from the Whimwords system. The response will depend on whether banana has previously sent a message towards A. If banana has not sent any messages towards A through the Whimwords system, A would receive the following message back from the system:

Message entered. We'll notify you if there's a match.

This message indicates that mutuality has not yet been established, and so A's message had not been delivered but was instead held as pending inside the system. At this point, banana had not received any communication from the system.

However, if banana had sent a message towards Apple, and that message was pending at the time that A sent her message towards banana, the pending message from banana would now be delivered to A. Her message would also be delivered to banana.

A would receive a message similar to this, including whatever content banana specified in his/her message:

From ‘banana’: Contact me at 617 5555555. [Alternatively: Whim from ‘banana’: Hi . . . (To reply, text your message like this: ‘whim banana your Message’.]

At the same time, Banana would receive a message similar to this (if A didn't specify a custom message):

From ‘apple’: Contact me at 617 3474459 [Alternatively: Whim from ‘apple’: Hi . . . (To reply, text your message like this: ‘whim apple yourMessage’)].
or this (if A did specify a custom message):
From ‘apple’: Hi there. Email me at alice@gmail.com

In the current version of the system, mutuality may be treated as either a transient or a persistent property. If the mutuality is transient, after A's message had been delivered to banana and banana's message had been delivered to A, the system would “forget” about the match. In order for a subsequent delivery to be made, the two users would need to each send a message towards each other and reestablish mutuality.

In a preferred embodiment, the system sets the mutuality as persistent, either permanent or for a set period. For example, mutuality may persist for a total of 5 followup messages, where the count is shared among the two users. So, after A's message had been delivered to banana and banana's message had been delivered to A, the system would remember the match. Subsequent messages sent from A to B or from B to A would be delivered directly. After A and B had sent a total of 5 messages, the match would be forgotten and subsequent messages would once again be subject to the mutuality condition. In order for a subsequent delivery to be made, the two users would need to each send a message towards each other and reestablish mutuality.

Here is an example of how the current Whimwords system could be used in a party context where the guests wear nametags.
1. At the beginning of the party, Alice sends whim r apple to 32075
2. Alice receives response from 32075 saying Registration successful . . .
3. Alice writes Apple on her nametag. She wears this tag throughout the party.
4. At the beginning of the party Bob sends whim r banana to 32075
5. Bob receives a response from 32075 saying Registration successful . . .
6. Bob writes Banana on his nametag. He wears this tag throughout the party.
7. Alice and Bob encounter each other at the party and notice the Whimwords written on each other's nametags (Alice's says Apple and Bob's says Banana).
8. Alice and Bob leave the party separately, without exchanging contact information
9. Alice decides she wants to reconnect with Bob, so she sends “whim s banana” to 32075
10. Alice receives a response from 32075 saying “Message entered. We'll notify you if there's a match.” Bob does not receive any communication from the system at this point.
11. Bob decides he wants to reconnect with Alice, so he sends “whim s apple” to 32075
12. A this point mutuality has been established, so the system delivers the messages sent by the two parties towards each other. Alice receives message from 32075 saying “From ‘banana’: Contact me at 6175555555.”
   Bob receives a message from 32075 saying “From ‘apple’: Contact me at 6173474459.”
13. Now Bob and Alice have each other's cell phone numbers and can call each other directly and have a conversation. They now know of each other's mutual interest in reconnecting.
14. If Alice were to send another message of the form “Whim s banana” to 32075, her message would be delivered immediately to Bob, because mutuality has already been established. Alice would receive an acknowledgement from the system indicating “Followup sent to ‘banana’.” However, after Alice and Bob exchanged a total of 5 such followups, subsequent messages would again be held in the system until mutuality had been re-established.

Each of the patent documents and scientific publications disclosed hereinabove is incorporated by reference herein for all purposes.

While the invention has been described with certain embodiments so that aspects thereof may be more fully understood and appreciated, it is not intended to limit the invention to these particular embodiments. On the contrary, it is intended to cover all alternatives, modifications and equivalents as may be included within the scope of the invention as defined by the appended claims.

What is claimed is:

1. A communication system comprising a processor that is programmed to process both a sender address and a recipient address of a first incoming message and of a second incoming message, and to deliver both messages only after finding a match (a) between a recipient address of the first incoming message and a sender address of the second incoming message, and (b) between a recipient address of the second incoming message and a sender address of the first incoming message.

2. The communication system of claim 1 wherein the processor is programmed to process electronic mail messages.

3. The communication system of claim 1 wherein the processor is programmed to process information consisting of voicemail messages, SMS text messages, instant messages (IM) and live telephone calls.

4. The communication system of claim 1 wherein the match is programmed to be partial identicalness.

5. The communication system of claim 1 wherein the match is programmed to be full identicalness.

6. The communication system of claim 1 wherein each incoming message further comprises a field of subject matter, and the processor is programmed to require a further match in the subject matter before delivery of both messages.

7. The communication system of claim 1 wherein each recipient address comprises an alphanumerical value.

8. The communication system of claim 1 wherein each recipient address comprises a graphic value.

9. The communication system of claim 1 wherein the system is configured to connect to a network.

10. The communication system of claim 9 wherein the network is the internet.

11. The communication system of claim 1 where at least one of the recipient addresses is a fuzzy address.

12. The communication system of claim 11 wherein the fuzzy address comprises information known to both the sender and the recipient.

13. The communication system of claim 11 wherein the fuzzy address comprises information on an encounter between the sender the recipient.

14. The communication system of claim 11 wherein the fuzzy address comprises information on the recipient's profession.

15. The communication system of claim 11 wherein the fuzzy address comprises information on the recipient's recreational activities.

16. The communication system of claim 11 wherein the fuzzy address comprises a narrative.

17. The communication system of claim 1, wherein the system further comprises a mutuality database, and wherein the processor is programmed to conclude from the match that a party mutuality exists between the two messages and records the party mutuality in the mutuality database to allow future communication delivered automatically between the sender and recipient of the two messages.

18. An email system that requires matching a recipient of a first email with a sender of a second email and a sender of the first email with a recipient of the second email before delivery of both emails.

19. The email system of claim 18 wherein the system requires full identicalness in matching.

20. An email system that is configured to deliver a first email from a sender towards a recipient with a fuzzy address as long as the email system is able to match the first email with a second email from the recipient towards the sender.
